(19) United States
(12) Patent Application Publication
(10) Pub. No.: US 2022/0107992 A1
(43) Pub. Date: Apr. 7, 2022

(54) Detecting Trend Changes in Time Series Data

(71) Applicant: Business Objects Software LTD, Dublin (IE)

(72) Inventors: Ahmet Yoldemir, Langely (CA); Alexander MacAulay, Vancouver (CA)

(21) Appl. No.: 17/062,338

(22) Filed: Oct. 2, 2020

(51) Int. Cl. G06F 17/18; G06F 17/40; G06F 17/12

(52) U.S. Cl. CPC G06F 17/18; G06F 17/12; G06F 17/40

(57) ABSTRACT

Some embodiments provide a method for identifying and pruning breakpoints in time series data. The method receives time series data. The method then generates a plurality of piecewise linear regression models that fit the time series data. The plurality of piecewise linear regression models may have differing numbers of breakpoints. The method further calculates an information criterion for each of the plurality of piecewise linear regression models. Next, the method selects one of the plurality of piecewise linear regression models having a lowest information criterion. Additionally, the method determines, for each breakpoint in the selected model, whether the prune each breakpoint. The method prunes one or more breakpoints in the set of breakpoints that are determined to be pruned.

### BACKGROUND

In data analytics, many different techniques and approaches may be used to analyze sets of data and discover useful information from the sets of data. Trends, for example, are statistically detectable movements of some quantifiable metric over time. Detecting these trends in time series data may be useful to a user. Moreover, detecting changes to or structural breaks in trends may also be useful to the user. Both trends and structural breaks in trends may be used in predictive analytics, which serves to identify likelihoods of future outcomes based on historical data. However, visually inspecting time series data to identify trends and structural breaks may be tedious and intractable.

### SUMMARY

In some embodiments, a method includes receiving time series data. The method includes generating a plurality of piecewise linear regression models that fit the time series data where the plurality of piecewise linear regression models have differing numbers of breakpoints. The method further includes calculating an information criterion for each of the plurality of piecewise linear regression models. The method additionally includes selecting one of the plurality of piecewise linear regression models having a lowest information criterion. The selected piecewise linear regression model has a set of breakpoints and a set of segments. The method moreover includes, for each breakpoint in the set of breakpoints, determining whether to prune each breakpoint and pruning the breakpoints determined to be pruned.

In some embodiments, the method further includes, for a particular breakpoint that is not pruned, generating a notification for the particular breakpoint and for a particular breakpoint that is pruned, discarding the particular breakpoint without generating the notification for the particular breakpoint.

In some embodiments, determining whether to prune each breakpoint includes calculating a p-value that a preceding segment to a breakpoint and a succeeding segment to the breakpoint lie on a same line, determining to prune the breakpoint when the p-value is above a threshold, and determining not to prune the breakpoint when the p-value is below a threshold. In these embodiments, the threshold is calculated from the sensitivity setting.

In some embodiments, calculating the p-value includes determining a probability that a slope and intercept of the preceding segment is equal to a slope and intercept of the succeeding segment.

In some embodiments, the method further includes determining, based on the time series data, a seasonality interval in the time series data. In these embodiments, the seasonality interval is used as a minimum on segment size when generating the plurality of piecewise linear regression models.

In some embodiments, the information criterion measures goodness of fit that is penalized by an increasing number of breakpoints.

In some embodiments, the method also includes detecting one or more outliers in the time series data and excluding the one or more outliers when generating the plurality of piecewise linear regression models.

In some embodiments, a non-transitory machine-readable medium stores a program executable by at least one processing unit of a device. The program includes sets of instructions for receiving time series data. The program may also include sets of instructions for generating a plurality of piecewise linear regression models that fit the time series data, the plurality of piecewise linear regression models having differing numbers of breakpoints. The program may further include sets of instructions for calculating an information criterion for each of the plurality of piecewise linear regression models. The program additionally includes sets of instructions for selecting one of the plurality of piecewise linear regression models having a lowest information criterion. The selected piecewise linear regression model has a set of breakpoints and a set of segments. The program further includes sets of instructions for determining, for each breakpoint in the set of breakpoints, whether to prune each breakpoint. The program moreover includes instructions for pruning those breakpoints in the set of breakpoints that are determined to be pruned.

In some embodiments, the program further includes sets of instructions for, for a particular breakpoint that is not pruned, generating a notification for the particular breakpoint, and, for a particular breakpoint that is pruned, discarding the particular breakpoint without generating the notification for the particular breakpoint.

In some embodiments, determining whether to prune each breakpoint includes calculating a p-value that a preceding segment to a breakpoint and a succeeding segment to the breakpoint lie on a same line, determining to prune the breakpoint when the p-value is above a threshold, determining not to prune the breakpoint when the p-value is below a threshold. In these embodiments, the threshold is calculated from the sensitivity setting.

In some embodiments, calculating the p-value includes determining a probability that a slope and intercept of the preceding segment is equal to a slope and intercept of the succeeding segment.

In some embodiments, the threshold is calculated by receiving a sensitivity setting, transforming the sensitivity setting into a corresponding p-value, correcting for multiple comparisons in the selected piecewise linear regression model by applying a correction to the corresponding p-value. In these embodiments, the correction is based on a number of breakpoints in the set of breakpoints.

In some embodiments, the program further includes sets of instructions for determining, based on the time series data, a seasonality interval in the time series data. In these embodiments, the seasonality interval is used as a minimum on segment size when generating the plurality of piecewise linear regression models.

In some embodiments, the information criterion measures goodness of fit that is penalized by an increasing number of breakpoints.

In some embodiments, a system includes a set of processing units and non-transitory machine-readable medium storing instructions. The instructions cause the processing unit to receive time series data and generate a plurality of piecewise linear regression models that fit the time series data. The plurality of piecewise linear regression models have differing numbers of breakpoints. The instructions further cause the at least one processing unit to calculate an information criterion for each of the piecewise linear regression models. The instructions also cause the at least one processing unit to select one of the plurality of piecewise linear regression models having the lowest information criterion. The selected piecewise linear regression model has a set of breakpoints and a set of segments. For each breakpoint in the set of breakpoints, the instructions cause the at least one processing unit to determine whether to prune each breakpoint. Additionally, the instructions cause the at least one processor to prune those breakpoints determined to be pruned.

In some embodiments, the instructions further cause the at least one processing unit to, for a particular breakpoint that is not pruned, generate a notification for the particular breakpoint and, for a particular breakpoint that is pruned, discard the particular breakpoint without generating the notification for the particular breakpoint.

In some embodiments, determining whether to prune each breakpoint includes calculating a p-value that a preceding segment to a breakpoint and a succeeding segment to the breakpoint lie on a same line, determining to prune the breakpoint when the p-value is above a threshold, determining not to prune the breakpoint when the p-value is below a threshold. In these embodiments, the threshold is calculated from the sensitivity setting.

In some embodiments, calculating the p-value includes determining a probability that a slope and intercept of the preceding segment is equal to a slope and intercept of the succeeding segment.

In some embodiments, the instructions further cause the at least one processing unit to determine, based on the time series data, a seasonality interval in the time series data. In these embodiments, the seasonality interval is used as a minimum on segment size when generating the plurality of piecewise linear regression models.

The following detailed description and accompanying drawings provide a better understanding of the nature and advantages of various embodiments of the present disclosure.

### BRIEF DESCRIPTION OF THE DRAWINGS

FIG. 1 illustrates a system for detecting trend changes in time series data according to some embodiments.

FIG. 2 illustrates a process for detecting trend changes in time series data according to some embodiments.

FIG. 3 shows sample data that will be used for discussion with respect to FIGS. 4-13 according to some embodiments.

FIG. 4 shows an exemplary process performed by an outlier filter module according to some embodiments.

FIG. 5 shows an exemplary process performed by a seasonality module according to some embodiments.

FIG. 6 shows an autocorrelation function plot of sample data according to some embodiments.

FIG. 7 shows an exemplary process performed by a model fitting module according to some embodiments.

FIG. 8 illustrates an exemplary process performed by a model selecting module according to some embodiments.

FIG. 9 illustrates a plot of residual sum of squares (RSS) and Bayesian Information Criterion (BIC) associated with models having differing numbers of breakpoints according to some embodiments.

FIG. 10 illustrates an exemplary process performed by a sensitivity setting module according to some embodiments.

FIG. 11 shows an exemplary process performed by a breakpoint pruning module according to some embodiments.

FIG. 12 shows a piecewise linear regression model and p-values associated with its breakpoints according to some embodiments.

FIG. 13 illustrates an exemplary process performed by a breakpoint notification manager according to some embodiments.

FIG. 14 illustrates a process for identifying breakpoints in time series data and for pruning certain breakpoints that are of less statistical significance according to some embodiments.

FIG. 15 illustrates an exemplary a computer system for implementing various embodiments described above.

FIG. 16 illustrates an exemplary computing device for implementing various embodiments described above.

FIG. 17 illustrates an exemplary system for implementing various embodiments described above.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for detecting trend changes in time series data and alerting users about such changes. As used herein, structural changes in trends may be referred to as breakpoints. In some embodiments, a computing system may retrieve time series data from a database. The computing system may filter the time series data for outliers and discard such outliers from the time series data. Next, the computing system may process the time series data to define a minimum segment size to be used when generating piecewise linear regression models that fit the time series data. The minimum segment size may be defined to be at least as large as a seasonality interval associated with the time series data. Next, the computing system generates a group of piecewise linear regression models that fit the time series data. Each piecewise linear regression model includes a certain number of segments that approximates data points in the time series data as well as a certain number of breakpoints between adjacent segments. The different piecewise linear regression models in the group may have differing numbers of segments and breakpoints. Next, the computing system selects one piecewise linear regression model in the group based on an information criterion associated with each model in the group. The computing system then determines whether to prune any breakpoints in the selected piecewise linear regression model. The determination of whether or not to prune certain breakpoints may be based on a sensitivity setting that the user may customize Next, the computing system may generate a notification relating to those breakpoints that were not pruned. Breakpoints that were pruned may be left out of the notification.

The techniques described in the present application provide a number of benefits and advantages over conventional methods of detecting breakpoints. Generally speaking, not all breakpoints are created equal. Some breakpoints can represent a substantial break from a previous trend and the beginning of new trend. Other breakpoints, while statistically detectable, may not represent as significant of a break from a previous trend. Conventional analytics platforms may generate notifications for all detected breakpoints, regardless of significance. This may result in a wasteful use of processing and network resources. By pruning certain breakpoints and selectively notifying a user of significant breakpoints, the presently described techniques provide more efficient uses of processing and network resources in analytics platforms.

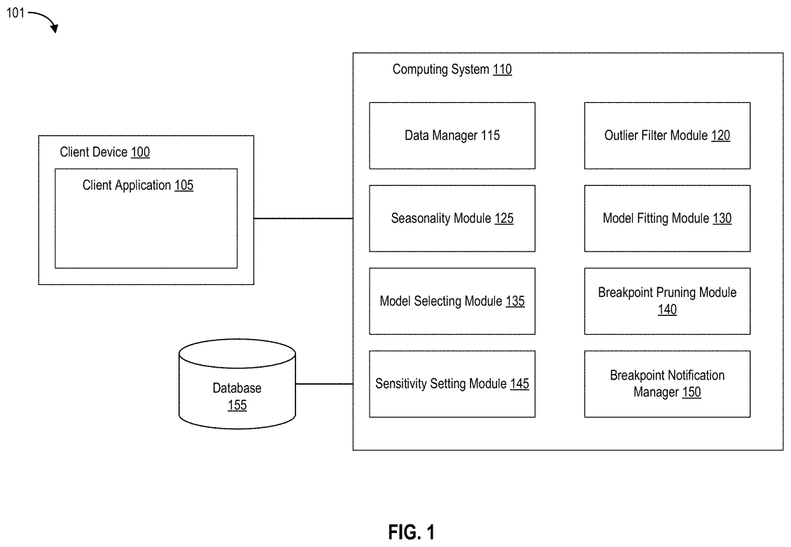

FIG. 1 illustrates a system 101 for detecting trend changes in time series data according to some embodiments. As shown, system 101 includes client device 100, computing system 110, and database 155. Database 155 is configured to store, among other data, time series data. In certain embodiments, time series data refers to a series of data points indexed at discrete times. While FIG. 1 shows database 155 as external to computing system 110, one of ordinary skill in the art will appreciate that database 155 may be part of computing system 110.

Client device 100 can be configured to communicate and interact with computing system 110. For example, client device 100 is shown to include client application 105 operating on client device 100. Client application 105 may be a desktop application, a mobile application, a web browser, etc. A user of client device 100 may use client application 105 to access computing system 110. For example, a user of client device 100 may use client device 100 to access analytics data generated by computing system 110 and view notifications generated by computing system 110. Moreover, client application 105 may include a user interface through which the user can specify a sensitivity setting for computing system 110 to use when pruning breakpoints. When the user provides a sensitivity setting to client application 105 via the user interface, client application 105 sends the sensitivity setting to computing system 110.

Computing system 110 serves to perform data analytics on data. For instance, computing system 110 may be configured to retrieve and process time series data, detect trends and breakpoints in the time series data, prune certain breakpoints according to user-defined sensitivity settings, and generate one or more notifications related to the breakpoints that are not pruned. As shown in FIG. 1, computing system 110 includes data manager 115, outlier filter module 120, seasonality module 125, model fitting module 130, model selecting module 135, breakpoint pruning module 140, sensitivity setting module 145, and breakpoint notification manager 150. Data manager 115 is configured to retrieve time series data from, for example, database 155. In some embodiments, data manager 115 may generate and send a query to database 155 to retrieve time series data. Once data manager 115 retrieves time series data, data manager 115 sends the time series data to outlier filter module 120.

Outlier filter module 120 is configured to identify and filter out outliers from the retrieved time series data. Outliers may be data in the time series data that differ in a statistically significant way from other data in the time series data. In some situations, outliers in the time series data may distort models to be fit to the time series data. Accordingly, outlier filter module 120 may remove these outliers from the time series data prior to modeling the time series data. In some embodiments, outlier filter module 120 may use a Hampel filter to detect the outliers. Once outliers are filtered out of the time series data, outlier filter module 120 sends the time series data to seasonality module 125 and model fitting module 130 for processing.

Seasonality module 125 is configured to define a minimum segment size to be used for modeling the time series data. Seasonality module 125 receives the time series data from outlier filter module 120. In many circumstances, time series data may exhibit seasonality. As used herein, seasonality refers to variations occurring at regular and defined intervals, such as yearly, quarterly, monthly, weekly, daily, etc. Seasonality may explain how similar patterns occur from season to season. For example, traffic on a nearby highway may exhibit weekly seasonality, since traffic volume tends to be greater on workdays than on weekends. Seasonality may serve to explain this pattern of decreased traffic volume on weekends week after week. When looking at trends in traffic volume on that highway, it may be useful to look beyond of week of data before making an inference about a change in traffic trends. For example, a decrease in traffic volume on the weekends that repeats is more likely due to seasonality rather than an actual break in trend.

Seasonality module 125 may detect whether the time series data exhibits seasonality and, if so, determine its interval. Seasonality module 125 may then define the minimum segment size to be equal to the seasonality interval. In some embodiments, seasonality module 125 may perform autocorrelation on the time series data. For the highway traffic example mentioned above, seasonality module 125 may set the minimum segment size to 7 days. In some embodiments, seasonality module 125 may define the minimum segment size to be the larger of the seasonality interval and a defined threshold segment size. So, if the seasonality interval is less than the defined threshold segment size (or if there is no seasonality), seasonality module 125 may define the minimum segment size to be the defined threshold segment size instead of the seasonality interval. Seasonality module 125 then outputs the minimum segment size to model fitting module 130.

Model fitting module 130 serves to generate a group of piecewise linear regression models to fit the time series data. Model fitting module 130 may receive the time series data from outlier filter module 120 and the minimum segment size from seasonality module 125. Piecewise linear regression models, also known as broken-stick regression models, are segmented linear regression models in which the independent variable (e.g., time) is partitioned into intervals and a separate segment is used to fit each interval. Breakpoints are defined as the boundaries between neighboring segments. In some embodiments, the model fitting module 130 generates the group of piecewise linear regression models (or simply “models”) to have differing numbers of segments and breakpoints. For example, if the time series data relates to highway traffic over a span of 6 weeks, a first model may have 1 segment and 0 breakpoints, a second model may have 2 segments and 1 breakpoint, a third model may have 3 segments and 2 breakpoints, and so on. Thus, each model in the group of models may have differing numbers of segments and breakpoints. In some embodiments, model fitting module 130 may determine a maximum number of breakpoints based on the number of data points and the minimum segment size. Next, model fitting module 130 may generate a model for each number in the range 0 and the maximum number of breakpoints. For example, if the time series data has 20 data points and the minimum segment size is determined to be 5, model fitting module 130 may determine that the maximum number of segments used to fit the 20 data points is 4 segments. As a result, model fitting module 130 may determine that the maximum number of breakpoints used to fit the 20 data points is 3. Model fitting module 130 may then generate 4 models, a first having 0 breakpoints, a second having 1 breakpoint, a third having 2 breakpoints, and a fourth having 3 breakpoints.

Additionally, model fitting module 130 may use the minimum segment size to constrain the size of segments in the group of models. Continuing with the above example, since the minimum segment size is 1 week and the data spans 6 weeks, model fitting module 130 may generate models having up to but not more than 6 segments and 5 breakpoints. This is because a model with 7 segments and 6 breakpoints would have at least one segment that is less than the minimum segment size of 1 week. Once model fitting module 130 generates the group of models, model fitting module 130 sends the group of models to model selecting module 135.

Model selecting module 135 serves to select a model from the group of models that is well fit but not over-fit. For example, model selecting module 135 may select the model having a low residual sum of squares (RSS) while using the least number of segments and breakpoints in doing so. Model selecting module 135 may receive the group of models from model fitting module 130. In response, model selecting module 135 may calculate an information criterion for each of these models. In some embodiments, the information criterion penalizes a goodness of fit measure (e.g., RSS) of a given model by the number of breakpoints used by the model. In these embodiments, the model with the lowest information criterion will have achieved a low RSS with low number of breakpoints. In some embodiments, the information criterion may be a Bayesian Information Criterion (BIC). Once model selecting module 135 calculates an information criterion for each of the models, it may then select the model with the lowest information criterion. Model selecting module 135 may then send the selected model to breakpoint pruning module 140.

Sensitivity setting module 145 serves to calculate a p-value threshold based on a user-defined sensitivity setting. For example, sensitivity setting module 145 may receive a sensitivity setting from client device 100. In response, sensitivity setting module 145 may calculate the p-value threshold from the user-defined sensitivity setting. In some embodiments, the p-value threshold represents a threshold over which breakpoints are to be discarded. Once calculated, sensitivity setting module 145 may send the p-value threshold to a storage of computing system 110 for retrieval by breakpoint pruning module 140.

Breakpoint pruning module 140 is configured to identify breakpoints that are of lesser statistical significance and to prune such breakpoints. As noted above, breakpoints generally have varying degrees of statistical significance. Each breakpoint is associated with a probability of being explained by an actual structural change in trend. Likewise, each breakpoint is associated with a probability of being explained by random events. Breakpoint pruning module 140 serves to identify and prune breakpoints that are likely to not represent an actual structural change in trend.

As noted above, breakpoint pruning module 140 receives a model from model selecting module 135. Breakpoint pruning module 140 may also retrieve the p-value threshold as calculated by sensitivity setting module 145 from storage. The model may have a set of breakpoints. Breakpoint pruning module 140 may generate a p-value for each of the breakpoints in the set. The p-value may, for example, represent the likelihood that the corresponding breakpoint is explained by random events (and not by a structural break in trend). In some embodiments, breakpoint pruning module 140 uses the Chow Test to generate p-values for each breakpoint. Next, breakpoint pruning module 140 may identify breakpoints with p-values that are greater than the p-value threshold. Breakpoint pruning module 140 may then prune these breakpoints, for example, by removing them from the model. Once breakpoint pruning module 140 removes these breakpoints from the model, breakpoint pruning module 140 may then send the model to breakpoint notification manager 150. Furthermore, breakpoint pruning module 140 may send the p-values corresponding to the remaining unpruned breakpoints to breakpoint notification manager 150.

Breakpoint notification manager 150 is configured to generate notifications with information about breakpoints in the model. For example, breakpoint notification manger 150 may create a message regarding the breakpoints in the model. In some embodiments, breakpoint notification manager 150 may exclude pruned breakpoints from such notifications. Once generated, breakpoint notification manager 150 may communicate the notifications to client device 100 for presentation by client application 105.

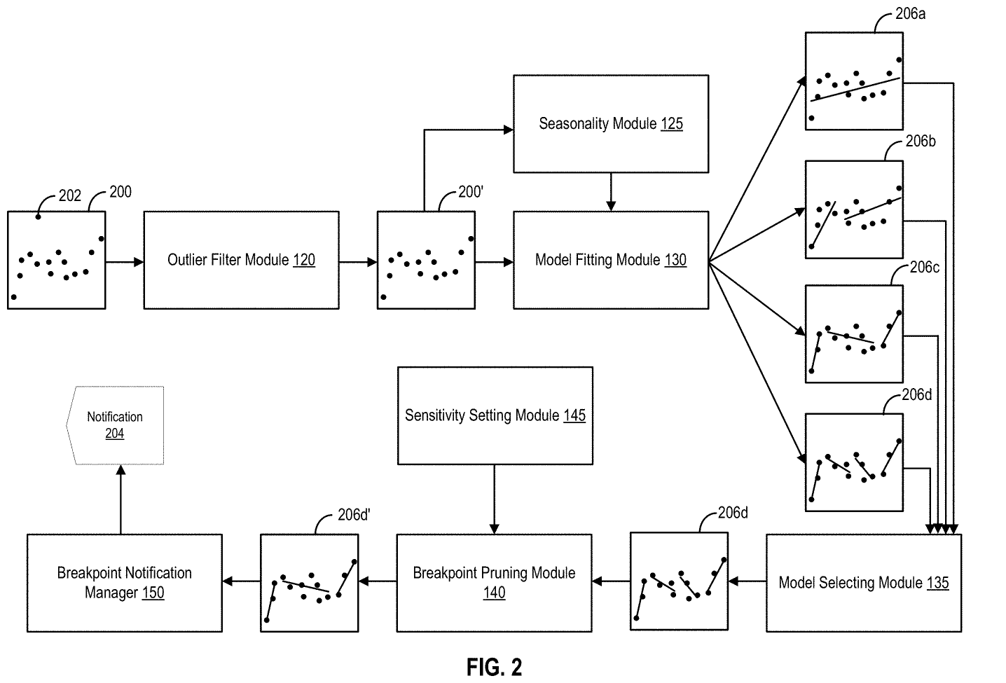

FIG. 2 illustrates a process for detecting trend changes in time series data according to some embodiments. As noted above, outlier filter module 120 serves to identify and remove outliers from time series data 200. As shown, outlier filter module 120 receives time series data 200, which includes an outlier 202. Time series data 200 is shown as a plot of data points in the time series data. In some embodiments, outlier filter module 120 may use a Hampel filter to identify outliers. In these embodiments, outlier filter module 120 may, for each data point in time series data 200, compute a median of a window comprising the data point and surrounding data points. Next, outlier filter module 120 may compute the standard deviation of each data point about its window median using the median absolute deviation (MAD). If a data point differs from the window median by more than K standard deviations, the data point may be replaced with the median. In this example, K may be a configurable parameter where a greater K would result in more “forgiving” filtering. On the other hand, a smaller K would result in more exacting filtering. In some embodiments, a user may wish to configure K depending on the nature of time series data 200. Once outlier filter module 120 removes outlier 202, outlier filter module 120 then outputs time series data 200′ to seasonality module 125 and model fitting module 130.

Seasonality module 125 serves to process time series data 200′ in order to define a minimum segment size to be used by model fitting module 130. Seasonality module 125 is shown to receive time series data 200′ from outlier filter module 120. Seasonality module 125 may process time series data 200′ to identify whether time series data 200′ exhibits seasonality and, if so, determine its interval. In some embodiments, seasonality module 125 identifies such seasonality by using autocorrelation. Autocorrelation is the correlation of a signal with a delayed copy of itself as a function of the delay (also known as “lag”). In the example shown, seasonality module 125 may determine that time series data 200′ does not exhibit any seasonality. In some embodiments, seasonality module 125 may set the minimum size to be the larger of the seasonality interval or a defined threshold segment size. Here, the defined threshold segment size may be 3 while the seasonality interval is 0 (e.g., time series data 200′ does not exhibit seasonality). As a result, seasonality module 125 may define the minimum segment size to be 3. Once seasonality module 125 defines the minimum segment size, seasonality module 125 outputs the minimum segment size to model fitting module 130.

Model fitting module 130 serves to generate models 206a-d from time series data 200′. For example, model fitting module 130 may use piecewise linear regression to fit piecewise linear regression models to data points in time series data 200′. As shown, model fitting module 130 receives time series data 200′ from outlier filter module 120 and the minimum segment size from seasonality module 125. Model fitting module 130 can then perform linear regression on time series data 200′ to generate models 206a-206d. In the example shown, model fitting module 130 generates models 206a-d to have differing numbers of breakpoints (and segments) from one another. For example, model 206a has 1 segment and 0 breakpoints, model 206b has 2 segments and 1 breakpoint, model 206c has 3 segments and 2 breakpoints, and model 206d has 4 segments and 3 breakpoints. Model fitting module 130 may generate models 206a-d to have differing numbers of breakpoints because it may not be known yet which number of breakpoints results in optimal fitting of time series data 200′. After models 206a-d are generated, model selecting module 135 may perform model selection on models 206a-d to identify one that is optimally fit. Also, as shown, model fitting module 130 uses the minimum segment size to constrain the minimal size of segments in models 206a-d. For example, no segment in models 206a-d is fit to less than 3 data points. Once model fitting module 130 generates models 206a-d, model fitting module 130 outputs models 206a-d to model selecting module 135.

Model selecting module 135 serves to select a model in models 206a-d. To do so, model selecting module 135 may calculate an information criterion for each of models 206a-d. The information criterion can be a metric that penalizes a goodness of fit measure (e.g., RSS) by the number of breakpoints used in the model. For example, an information criterion for model 206d may have a larger penalty term than those of models 206a-c because model 206d uses more parameters than models 206a-c. For instance, model 206d has 1 more breakpoint than model 206c, 2 more breakpoints than model 206b, and 3 more breakpoints than model 206a. In some embodiments, the information criterion may be a Bayesian Information Criterion (BIC). The model with the lowest BIC may represent the model that is well-fit without being over-fit. Here, model 206d may have the lowest information criterion (despite a larger penalty term). As a result, model selecting module 135 is shown to select model 206d. Model selecting module 135 may then send model 206d to breakpoint pruning module 140.

Sensitivity setting module 145 serves to calculate a p-value threshold from a user-defined sensitivity setting. The p-value threshold may then to be used to prune breakpoints by breakpoint pruning module 140. Although not shown in FIG. 2, sensitivity setting module 145 may receive a user-defined sensitivity setting, e.g., via client application 105. In one embodiment, the user-defined sensitivity setting may range from 0-100. Sensitivity setting module 145 may transform the user-defined sensitivity setting to the p-value threshold (e.g., between 0-1). Next, sensitivity setting module 145 stores the p-value threshold in a storage for retrieval by breakpoint pruning module 140.

Breakpoint pruning module 140 is configured to prune breakpoints in model 206d. Once breakpoint pruning module 140 receives model 206d, breakpoint pruning module 140 may calculate a p-value for each breakpoint. In some embodiments, the p-value represents the statistical significance associated with a breakpoint. For example, the p-value for a breakpoint may represent the probability that the apparent break in trend is due to random events rather than an actual structural break. In some embodiments, breakpoint pruning module 140 may use the Chow Test to calculate the p-value of each breakpoint. In this example, the breakpoint pruning module 140 may use the Chow Test to calculate the probability that a preceding segment to a breakpoint lies on the same line as a succeeding segment. In other words, the Chow Test tests whether the coefficients (e.g., slope and intercept) in two linear regressions (e.g., the preceding segment and the succeeding segment) are equal.

Breakpoint pruning module 140 may calculate a p-value for each of the 3 breakpoints shown in model 206d. Breakpoint pruning module 140 may then determine if any of these p-values are greater than the p-value threshold. Here, the p-value of the second, middle breakpoint is greater than the p-value threshold. As a result, breakpoint pruning module 140 prunes that breakpoint by, for example, removing it from model 206d. In some embodiments, breakpoint pruning module 140 may then refit data points previously fit by the segments adjacent to the pruned breakpoint. Once breakpoint pruning module 140 prunes breakpoints having p-values that are greater than the p-value threshold from model 206d, breakpoint pruning module 140 may then output model 206d′ to breakpoint notification manager 150.

In FIG. 2, breakpoint notification manager 150 generates notification 204 with information related to breakpoints in model 206d′, among other information. As shown, breakpoint notification manager 150 receives model 206d′ from breakpoint pruning module 140. In response, breakpoint notification manager 150 may extract information from model 206d′ to populate notification 204. For example, breakpoint notification manager 150 may populate notification 204 with information regarding the time-coordinates of the two breakpoints in model 206d′. In some embodiments, breakpoint notification manager 150 may order the breakpoints by the significance of their corresponding p-values. Breakpoint notification manager 150 may also populate notification 204 with information relating to the trends (e.g., the segments) occurring before and after each breakpoint. In some embodiments, breakpoint notification manager 150 may exclude any pruned breakpoints from notification 204. Once notification 204 is generated, breakpoint notification manager 150 may send notification 204 to a client device such as client device 100.

In some embodiments, breakpoint pruning module 140 may also prune breakpoints that are recurring at regular intervals even if their p-values are less than the p-value threshold. Consider, for example, time series data related to sales volume. This time series data may exhibit breakpoints nearing the end of each quarter reflecting a quarter-end push to close the quarter strong. While such breakpoints may indeed be structural breaks in trend, they may not warrant an alert to the user (e.g., because the user is expecting such breakpoints). In some embodiments, breakpoint pruning module 140 is further configured to detect whether a given breakpoint is another instance of a sequence of recurring breakpoints. In these embodiments, seasonality module 125 may estimate a seasonality in time series data 200′ by finding a secondary peak in autocorrelation data. Next, model fitting module 130 may generate, without using the minimum segment size set by seasonality module 125, one or more additional piecewise linear regression models to find these recurring breakpoints. Computing system 110 may then average out the input signal across periods to find the expected seasonal signal (e.g., sales revenue per month averaged across previous years). For example, given 5 previous years' worth of sales data, computing system 110 may perform an average across each January, each February, each March, and so on. This averaged signal may exhibit an increase at the month concluding each quarter, e.g., March, June, September, and December. Next, model fitting module 130 may find breakpoints on the averaged signal without using the minimum segment size. Continuing with the above example, model fitting module 130 may detect breakpoints in the averaged signal at the months concluding each quarter, e.g., March, June, September, and December. Since model fitting module 130 detected breakpoints in the signal averaged across previous years, model fitting module 130 determines that these breakpoints are recurring breakpoints (also referred to as expected breakpoints). Next breakpoint pruning module 140 may prune breakpoints that are identified in both the averaged signal and the current period (e.g., the current year). If, however, breakpoint pruning module 140 identifies a breakpoint in the current period but not in the averaged signal, breakpoint pruning module 140 determines that the breakpoint is not a recurring breakpoint. As a result, breakpoint pruning module 140 does not prune such breakpoints and breakpoint notification manager 150 may include these breakpoints in notification 204. Continuing with the present example, if the current period includes a breakpoint at any of March, June, September, or December, breakpoint pruning module 140 may prune this breakpoint, since this breakpoint is an expected breakpoint. If, on the other hand, the current period includes a breakpoint in January, breakpoint pruning module 140 may determine not to prune this breakpoint, since it is not a recurring breakpoint.

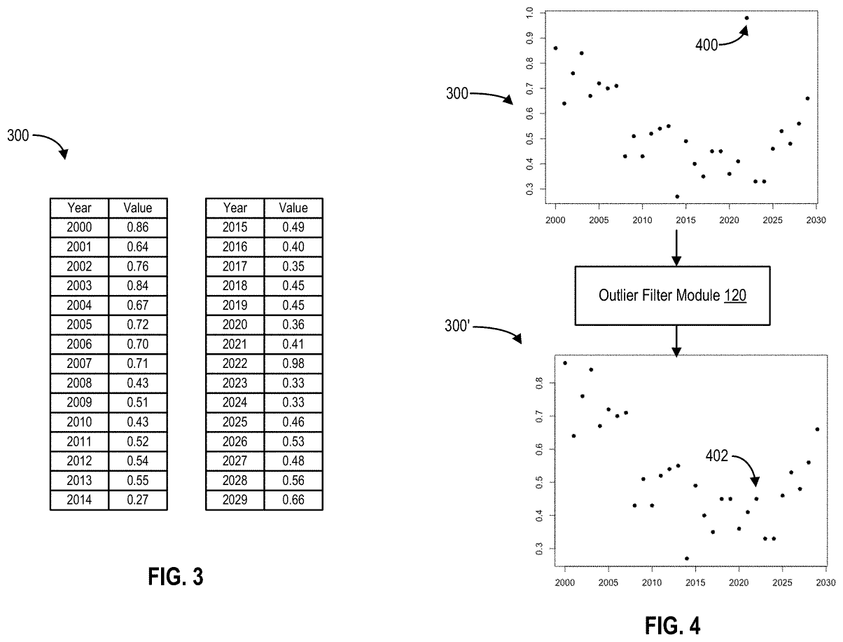

FIG. 3 shows sample data 300 that will be used for discussion with respect to FIGS. 4-13 according to some embodiments. As shown, sample data 300 comprises 30 data points spanning a period of 30 years from year 2000 to year 2029. The values of sample data 300 range from 0.27 to 0.98.

FIG. 4 shows an exemplary process performed by outlier filter module 120 according to some embodiments. As shown, outlier filter module 120 filters outlier 400 from sample data 300 to produce sample data 300′. In this example, outlier filter module 120 uses a Hampel filter to filter for outliers in sample data 300. A Hampel filter identifies outliers by looking at a window surrounding each data point and determining how much a given data point differs from that window. More particularly, the Hampel filter calculates a median for a window and uses the mean absolute deviation (MAD) to calculate the window's standard deviation. When a data point differs from the median by more than 3 standard deviations, the Hampel filter may replace the data point with the median. In some embodiments, the standard deviation for a window is defined as σ≈1.4826*MAD. In the present example, outlier filter module 120 may calculate, for each data point in sample data 300, the median of a window of data points that include the data point and surrounding data points. For example, for the data point (2022, 0.98), outlier filter module 120 may compute the median of a window of five data points (0.36, 0.41, 0.98, 0.33, and 0.33 for this example) to be 0.36. Thus, the difference between the data point and the median of the window is 0.98−0.36=0.62. Next, outlier filter module 120 may compute the absolute deviations from the median to be (0, 0.05, 0.62, 0.03, and 0.03). From this, outlier filter module 120 may determine that the median absolute deviation is 0.03. Based on this, outlier filter module 120 may determine the standard deviation of this window to be 0.044. Because the difference between the data point and the median is greater than three times the standard deviation, outlier filter module 120 identifies this data point as an outlier 400 and removes it. In some embodiments, outlier filter module 120 replaces outlier 400 with a data point 402 equal to the median of the window (here, 0.36). Outlier filter module 120 then outputs sample data 300′ with outlier 400 removed.

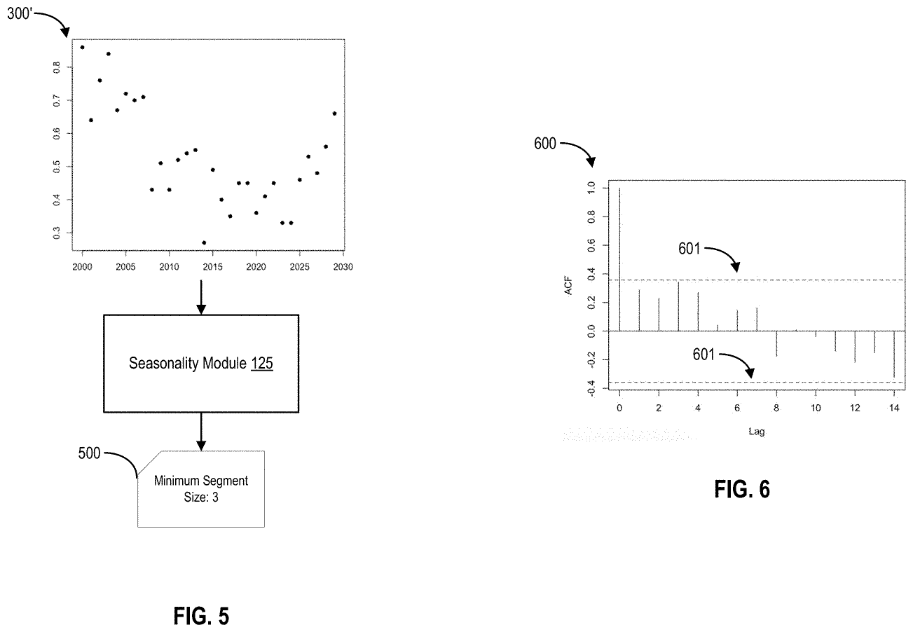

FIG. 5 shows an exemplary process performed by seasonality module 125 according to some embodiments. In particular, FIG. 5 shows seasonality module 125 determining a minimum segment size 500 for sample data 300′. As noted above, seasonality module 125 may define the minimum segment size 500 to be the larger of a seasonality interval associated with sample data 300′ or a defined threshold segment size. In some embodiments, the defined threshold segment size may be 3. The defined threshold segment size of 3 data points may be used to avoid over-fitting sample data 300′. For example, if the minimum segment size 500 were 2 data points, the resulting model may be over-fit because the model would pass through each data point. Such a model, while technically perfectly fit to the data point, would be vulnerable to noise. As a result, the defined threshold segment size of 3 may be used as a lower limit on minimum segment size 500.

To determine whether sample data 300′ exhibits seasonality, seasonality module 125 may apply autocorrelation to sample data 300′. The disclosure will briefly turn to FIG. 6 to describe an autocorrelation function (ACF) plot of sample data 300′.

FIG. 6 shows an ACF plot 600 of sample data 300′ according to some embodiments. For example, seasonality module 125 may calculate the correlation data shown in ACF plot 600. In ACF plot 600, the x-axis represents a lag in terms of years and the y-axis represents a correlation coefficient. The dashed lines 601 show a 95% confidence interval. In some embodiments, the seasonality module 125 may use the following equation to calculate the confidence interval.

ci=±^{z}^{_{(1+α)/2}}/\sqrt{N} (1)

In equation (1), α is the confidence level, N is the number of data points, and z is the cumulative distribution function of the standard normal distribution. For α=95% and N=30, seasonality module 125 may compute the confidence interval to be ±0.358. Correlation coefficients that are outside of this confidence interval are indicative of actual correlation and not statistical fluke. As shown, no lags (other than lag=0) in sample data 300′ has a correlation coefficient outside of the confidence interval of ±0.358. As a result, sample data 300′ does not exhibit seasonality.

Returning to FIG. 5, seasonality module 125 may determine that sample data 300′ does not exhibit seasonality (or seasonality interval=0). As a result, seasonality module 125 may define the minimum segment size 500 to be 3 data points.

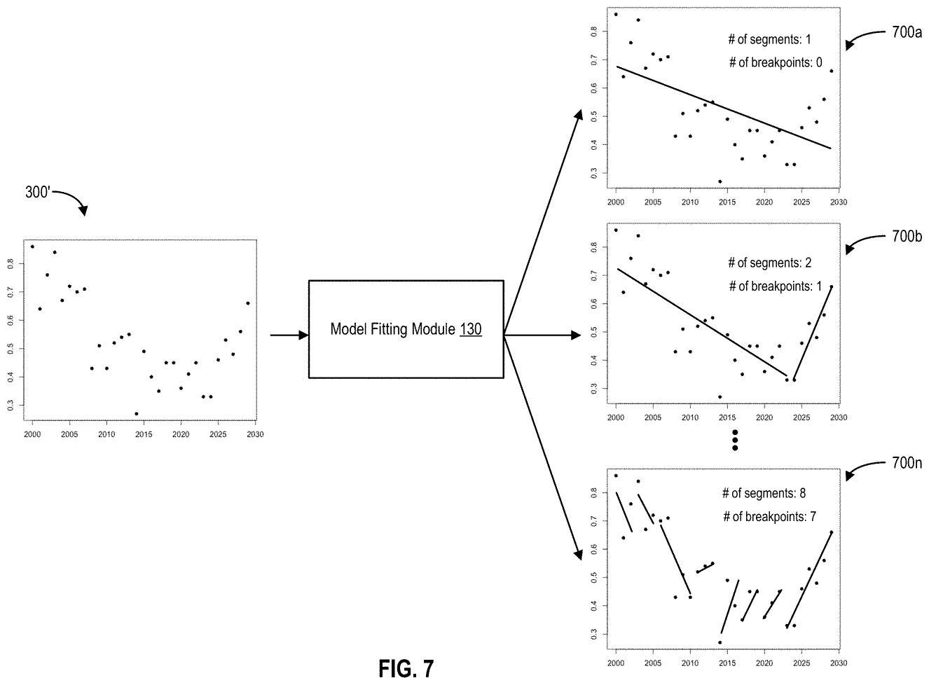

FIG. 7 shows an exemplary process performed by model fitting module 130 according to some embodiments. As shown, model fitting module 130 generates piecewise linear regression models 700a-n from sample data 300′. Model fitting module 130 generates models 700a-n to have differing numbers of segments and breakpoints. For example, model 700a has 1 segment and 0 breakpoints, model 700b has 2 segments and 1 breakpoint, and model 700n has 8 segments and 7 breakpoints. Additionally, model fitting module 130 may generate models 700a-n to have a minimum segment size of 3 data points (3 years in this example). Thus, for example, none of models 700a-n has segments spanning less than 3 data points. Furthermore, model fitting module 130 may allow for gap-ups and gap-downs when generating models 700a-n. That is, model fitting module 130 may permit discontinuity between adjacent segments. In model 700n, for example, the segment spanning years 2000-2002 is not continuous with the segment spanning years 2003-2006 (i.e., they do not touch).

In some embodiments, model fitting module 130 uses the following equation to generate models 700a-n.

yₜ=xₜ^{T}β^{(j)}+ϵₜ (2)

In the above equation, yₜ is the input time series signal, where t=nⱼ₋₁+1, . . . , nⱼ, and j=1, . . . , m+1; m is the number of breakpoints; j is the segment index; β^{(j)} is the segment-specific set of regression coefficients; {n₁, . . . , nₘ} is the set of unknown breakpoints; xₜ comprises the time points that are uniformly separated; and εₜ is the error term. This equation (or set of equations) is optimized by placing {n₁, . . . , nₘ} such that the residual sum of squares is minimized. Model fitting module 130 may use minimum segment size as a condition for where to place {n₁, . . . , nₘ}. In the present example, since the minimum segment size is 3 data points, model fitting module 130 may place {n₁, . . . , nₘ} to be spaced at least 3 years apart. To generate models 700a-n, model fitting module 130 may iteratively apply equation (2) to sample data 300′ with m=0, 1, 2, . . . . For example, model fitting module 130 may generate model 700a by applying equation (2) to sample data 300′ with m=0 (e.g., 0 breakpoints), generate model 700b by applying equation (2) with m=1 (e.g., 1 breakpoint), and so on.

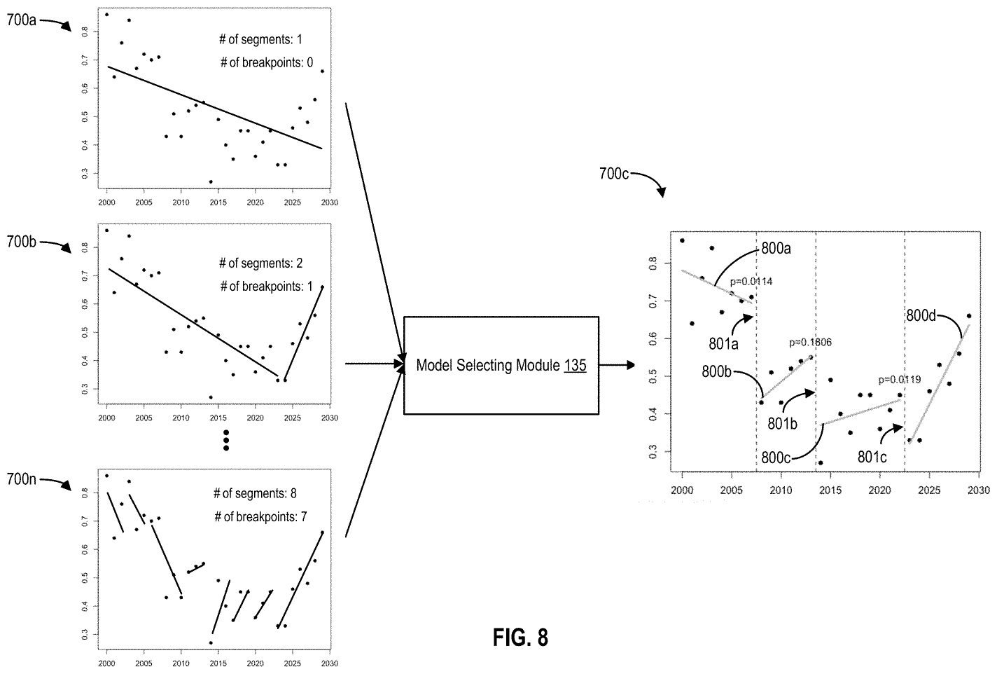

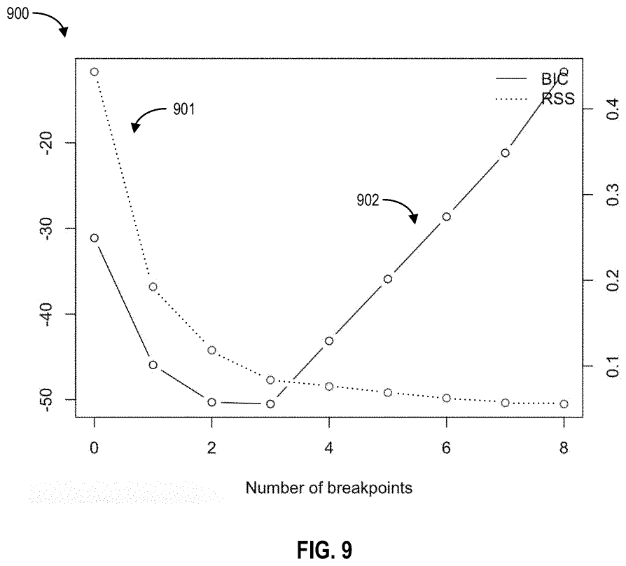

FIG. 8 illustrates an exemplary process performed by model selecting module 135 according to some embodiments. As shown, model selecting module 135 selects model 700c from models 700a-n. As noted above, model selecting module 135 may calculate an information criterion associated with each of models 700a-n and select one with the lowest information criterion. The information criterion may include a term for RSS and a penalty term for the number of breakpoints used. A lower information criterion may indicate a well-fit but not over-fit model. In some embodiments, a Bayesian Information Criterion (BIC) is used as the information criterion. The disclosure will briefly turn to FIG. 9 to describe a plot of the BIC associated with each of models 700a-n.

FIG. 9 illustrates a plot 900 of residual sum of squares (RSS) and BIC associated with models 700a-n according to some embodiments. For example, model selecting module 135 may calculate the RSS and BIC data shown in plot 900. RSS plot 901 shows that the RSS associated with models 700a-n decreases as the number of breakpoints used increases. This is because models with more breakpoints naturally are better able to fit data points and thereby reduce RSS. On the other hand, BIC plot 902 shows that the BIC associated with models 700a-n decreases from 0 to 3 breakpoints and increases from 3-8 breakpoints. The increase in BIC after 3 breakpoints reflects the penalty term counteracting RSS. As shown FIG. 9, the model with 3 breakpoints has the lowest BIC.

Returning to FIG. 8, model selecting module 135 may determine that, out of models 700a-n, model 700c is associated with the lowest BIC. As a result, model selecting module 135 selects model 700c. As shown model 700c includes segments 800a-d and breakpoints 801a-c. Segments 800a-d may be represented, respectively, by the following equations:

Between 2000 and 2007 (inclusive): yₜ=25.543−0.012xₜ (3)

Between 2008 and 2013 (inclusive): yₜ=−44.309+0.022xₜ (4)

Between 2014 and 2022 (inclusive): yₜ=−16.413+0.008xₜ (5)

Between 2023 and 2029 (inclusive): yₜ=−105.886+0.052xₜ (6)

The breakpoints 801a-c are positioned at the “breaks” or boundaries between segments 800a-d. Once selected, model selecting module 135 may send model 700c to breakpoint pruning module 140 to determine whether any of breakpoints 801a-c are to be pruned.

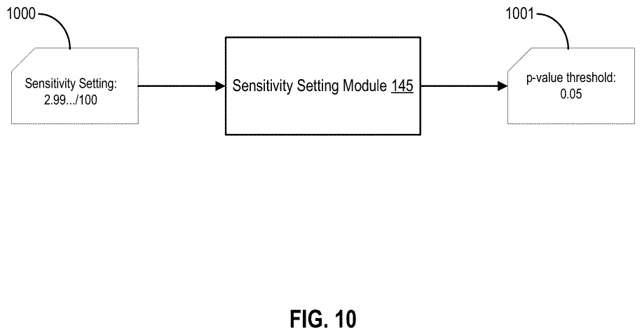

FIG. 10 illustrates an exemplary process performed by sensitivity setting module 145 according to some embodiments. As shown, sensitivity setting module 145 calculates a p-value threshold 1001 from a sensitivity setting 1000. Sensitivity setting 1000 is shown to be 2.99 on a scale of 0-100. Sensitivity setting module 145 can perform a transformation on the sensitivity setting 1000 to calculate p-value threshold 1001. In some embodiments, sensitivity setting module 145 may transform the sensitivity setting 1000 using the following equation.

p−value threshold=e^{-sensitivity setting} (7)

Here, sensitivity setting module 145 calculates p-value threshold 1001 to be 0.05. Once calculated, sensitivity setting module 145 may then send the p-value threshold 1001 to breakpoint pruning module 140 for determining whether any breakpoints in model 700c are to be pruned.

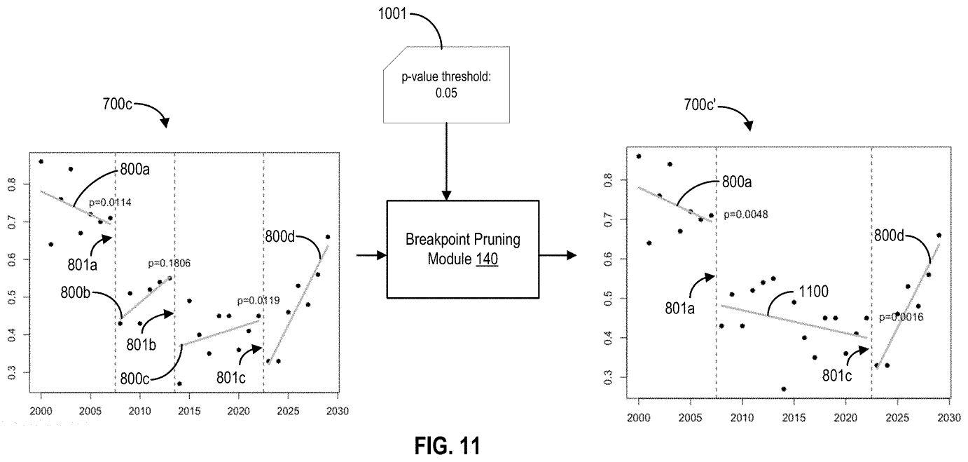

FIG. 11 shows an exemplary process performed by breakpoint pruning module 140 according to some embodiments. As shown, breakpoint pruning module 140 prunes breakpoint 801b from model 700c to generate model 700c′. As noted above, breakpoint pruning module 140 may identify breakpoints to prune by calculating a p-value for each of breakpoints 801a-c. In some embodiments, breakpoint pruning module 140 uses the Chow Test to calculate such p-values. In these embodiments, breakpoint pruning module 140 calculates a Chow metric for each of breakpoints 801a-c according to the following equation.

$$\frac{( {S}_{C} - ( {S}_{1} + {S}_{2} ) ) / k}{( {S}_{1} + {S}_{2} ) / ( {N}_{1} + {N}_{2} - 2 k )} \qquad ( 8 )$$

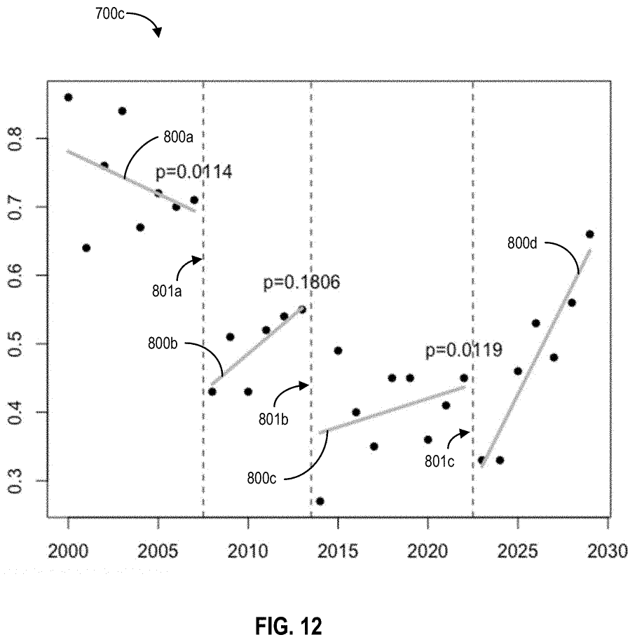

In equation (8), N₁ is the number of time points in the segment immediately preceding the tested breakpoint; N₂ is the number of time points in the segment immediately succeeding the tested breakpoint; k is the total number of parameters (here, k=2 to account for slope and intercept); S_{C} is the sum squared residuals from the combined data; S₁ is the sum of squared residuals from the segment immediately preceding the tested breakpoint; and S₂ is the sum of squared residuals from the segment immediately succeeding the tested breakpoint. Breakpoint pruning module 140 may then calculate p-values associated with each of breakpoints 801a-c based on the corresponding Chow metric. The discussion will turn for a moment to FIG. 12 to illustrate the p-values obtained by breakpoint pruning module 140.

FIG. 12 shows p-values associated with breakpoints 801a-c in model 700c according to some embodiments. As shown, breakpoint 801a has a p-value of p=0.0144, breakpoint 801b has a p-value of p=0.1806, and breakpoint 801c has a p-value of p=0.0119.

Returning to FIG. 11, breakpoint pruning module 140 may determine whether the p-values of breakpoints 801a-c are greater than the p-value threshold. In some embodiments, a correction may be applied to the p-value threshold prior to determining whether the p-values of breakpoints 801a-c are greater than the p-value threshold. Breakpoint pruning module 140 may apply this correction to counteract an effect of multiple comparisons. In these embodiments, breakpoint pruning module 140 may apply a Bonferroni correction to the p-value threshold. For instance, breakpoint pruning module 140 may divide the p-value threshold by the number of breakpoints in model 700c. This would result in a modified p-value threshold of p′=0.016. In this example, breakpoint pruning module 140 may discard breakpoints associated with a p-value that is greater than 0.016. Here, the p-value associated with breakpoint 801b is greater than the modified p-value threshold. As a result, breakpoint pruning module 140 may remove breakpoint 801b from model 700c to produce model 700c′. To remove breakpoint 801b, breakpoint pruning module 140 refits data points between years 2008-2022 with segment 1100 in place of segments 800b and 800c. As shown, breakpoint pruning module 140 may recalculate the p-values associated with breakpoints 801a and 801c. Here, with segment 1100, the p-value associated with breakpoint 801a is p=0.0048 and the p-value associated with breakpoint 801c is p=0.0016. Breakpoint pruning module 140 may then output model 700c′ to breakpoint notification manager 150.

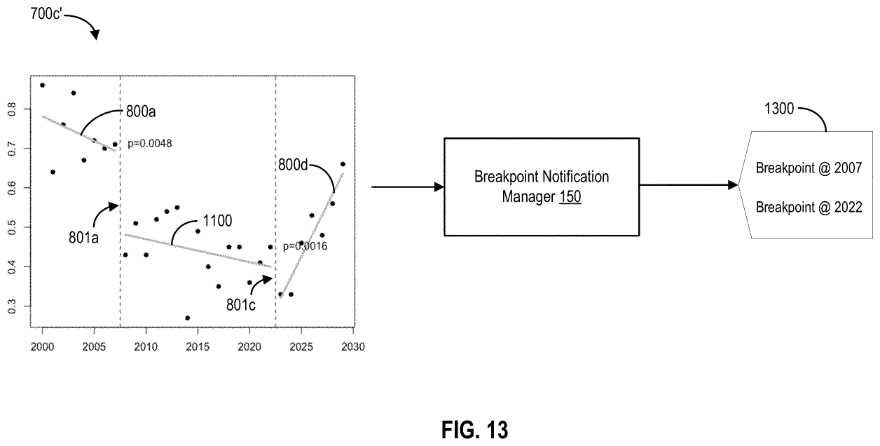

FIG. 13 illustrates an exemplary process performed by breakpoint notification manager 150 according to some embodiments. As shown, breakpoint notification manager 150 generates notification 1300 using information extracted from model 700c′. For example, breakpoint notification manager 150 may extract information relating to the time-coordinates of breakpoints in model 700c′, p-values associated with those breakpoints, gap-up or gap-down values at each breakpoint, among other information. As shown, breakpoint notification manager 150 includes time-coordinates associated with breakpoints 801a and 801c in notification 1300. Breakpoint notification manager 150 is shown to exclude information regarding breakpoint 801b. Once generated, breakpoint notification manager 150 may then send notification 1300 to a client device.

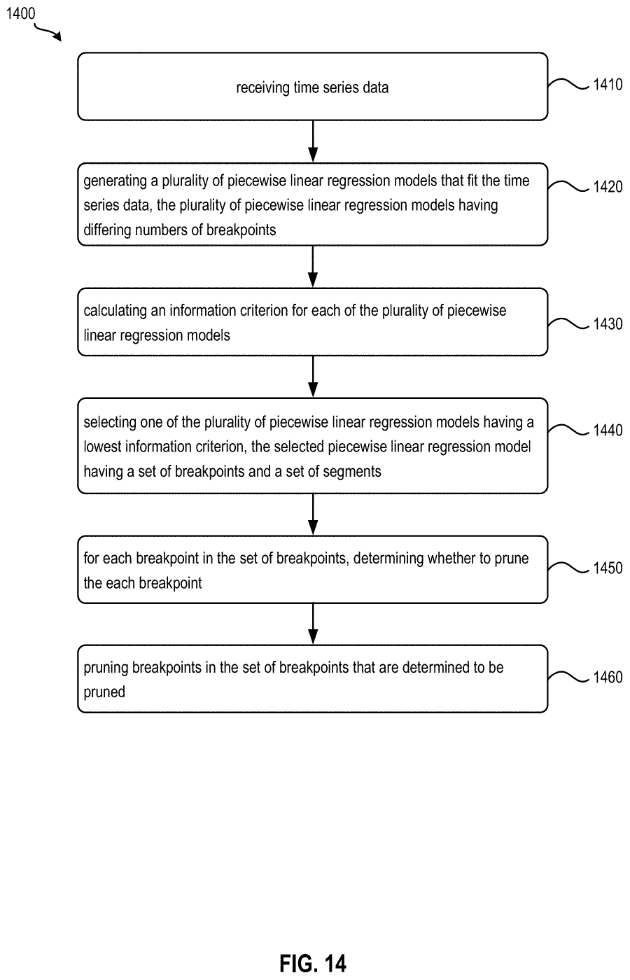

FIG. 14 illustrates a process 1400 for identifying breakpoints in time series data and pruning certain breakpoints that are of less statistical significance according to one embodiment. In some embodiments, computing system 110 performs process 1400. Process 1400 begins by receiving, at 1410, time series data. Referring to FIG. 1 as an example, model fitting module 130 may receive time series data from database 155 via data manager 115.

Next, process 1400 generates, at 1420, a plurality of piecewise linear regression models that fit the time series data. The plurality of piecewise linear regression models may have differing numbers of breakpoints. Referring to FIGS. 2 and 7 as an example, once model fitting module 130 receives time series data, model fitting module 130 generates a plurality of piecewise linear regression models 700a-n. Each model in models 700a-n has a different number of breakpoints from one another.

Process 1400 then calculates, at 1430, an information criterion for each of the plurality of piecewise linear regression models. Referring to FIGS. 2 and 8 as an example, model selecting module 135 may calculate an information criterion associated with each of models 700a-n. As noted above, the information criterion may be a BIC.

After operation 1430, process 1400 selects, at 1440, one of plurality of piecewise linear regression models having a lowest information criterion. Referring again to FIGS. 2 and 8, model selecting module 135 selects model 700c because it has the lowest information criterion.

Next, for each breakpoint in the set of breakpoints, process 1400 determines, at 1450, whether to prune the breakpoints. Referring to FIGS. 11 and 12 as an example, breakpoint pruning module 140 calculates a p-value for each of breakpoints 801a-c. In that example, breakpoint pruning module 140 uses the Chow Test to calculate the p-values for each of breakpoints 801a-c. Breakpoint pruning module 140 may then determine whether the p-value for any breakpoints 801a-c is greater than the p-value threshold 1001 or not. Since the p-value of breakpoint 801b is greater than the p-value threshold 1001, breakpoint pruning module 140 determines to prune it.

Finally, process 1400 prunes, at 1460, breakpoints that are determined to be pruned. Referring to FIGS. 2 and 11 as an example, after breakpoint pruning module 140 determines to prune breakpoint 801b, breakpoint pruning module 140 removes segments 800b and 800c and breakpoint 801b. Next, breakpoint pruning module 140 refits data points spanning years 2008-2022 with segment 1100. In this manner, breakpoint 801b is removed.

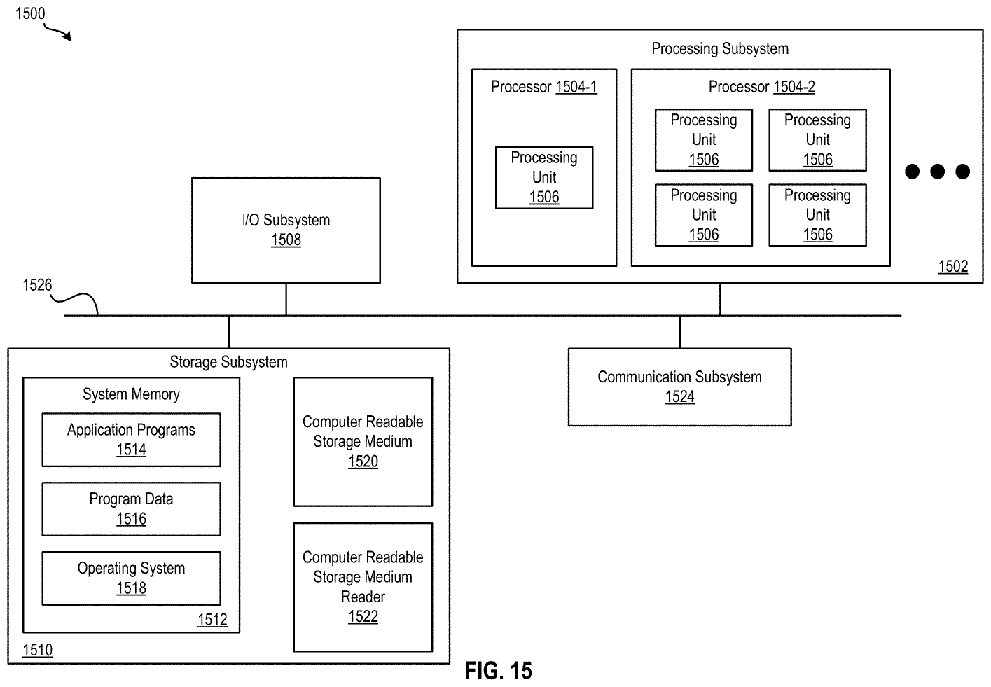

FIG. 15 illustrates an exemplary computer system 1500 for implementing various embodiments described above. For example, computer system 1500 may be used to implement client device 100 and computing system 110. Computer system 1500 may be a desktop computer, a laptop, a server computer, or any other type of computer system or combination thereof. Some or all elements of client application 105, data manager 115, outlier filter module 120, seasonality module 125, model fitting module 130, model selecting module 135, breakpoint pruning module 140, sensitivity setting module 145, breakpoint notification manager 150, or combinations thereof can be included or implemented in computer system 1500. In addition, computer system 1500 can implement many of the operations, methods, and/or processes described above (e.g., process 1400). As shown in FIG. 15, computer system 1500 includes processing subsystem 1502, which communicates, via bus subsystem 1526, with input/output (I/O) subsystem 1508, storage subsystem 1510 and communication subsystem 1524.

Bus subsystem 1526 is configured to facilitate communication among the various components and subsystems of computer system 1500. While bus subsystem 1526 is illustrated in FIG. 15 as a single bus, one of ordinary skill in the art will understand that bus subsystem 1526 may be implemented as multiple buses. Bus subsystem 1526 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 1502, which can be implemented as one or more integrated circuits (e.g., a conventional microprocessor or microcontroller), controls the operation of computer system 1500. Processing subsystem 1502 may include one or more processors 1504. Each processor 1504 may include one processing unit 1506 (e.g., a single core processor such as processor 1504-1) or several processing units 1506 (e.g., a multicore processor such as processor 1504-2). In some embodiments, processors 1504 of processing subsystem 1502 may be implemented as independent processors while, in other embodiments, processors 1504 of processing subsystem 1502 may be implemented as multiple processors integrate into a single chip or multiple chips. Still, in some embodiments, processors 1504 of processing subsystem 1502 may be implemented as a combination of independent processors and multiple processors integrated into a single chip or multiple chips.

In some embodiments, processing subsystem 1502 can execute a variety of programs or processes in response to program code and can maintain multiple concurrently executing programs or processes. At any given time, some or all of the program code to be executed can reside in processing subsystem 1502 and/or in storage subsystem 1510. Through suitable programming, processing subsystem 1502 can provide various functionalities, such as the functionalities described above by reference to process 1400, etc.

I/O subsystem 1508 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 1500 to a user or another device (e.g., a printer).

As illustrated in FIG. 15, storage subsystem 1510 includes system memory 1512, computer-readable storage medium 1520, and computer-readable storage medium reader 1522. System memory 1512 may be configured to store software in the form of program instructions that are loadable and executable by processing subsystem 1502 as well as data generated during the execution of program instructions. In some embodiments, system memory 1512 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 1512 may include different types of memory, such as static random access memory (SRAM) and/or dynamic random access memory (DRAM). System memory 1512 may include a basic input/output system (BIOS), in some embodiments, that is configured to store basic routines to facilitate transferring information between elements within computer system 1500 (e.g., during start-up). Such a BIOS may be stored in ROM (e.g., a ROM chip), flash memory, or any other type of memory that may be configured to store the BIOS.

As shown in FIG. 15, system memory 1512 includes application programs 1514 (e.g., client application 110a-n), program data 1516, and operating system (OS) 1518. OS 1518 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 1520 may be a non-transitory computer-readable medium configured to store software (e.g., programs, code modules, data constructs, instructions, etc.). Many of the components (e.g., client application 105, data manager 115, outlier filter module 120, seasonality module 125, model fitting module 130, model selecting module 135, breakpoint pruning module 140, sensitivity setting module 145, breakpoint notification manager 150) and/or processes (e.g., process 1400) described above may be implemented as software that when executed by a processor or processing unit (e.g., a processor or processing unit of processing subsystem 1502) performs the operations of such components and/or processes. Storage subsystem 1510 may also store data used for, or generated during, the execution of the software.

Storage subsystem 1510 may also include computer-readable storage medium reader 1522 that is configured to communicate with computer-readable storage medium 1520. Together and, optionally, in combination with system memory 1512, computer-readable storage medium 1520 may comprehensively represent remote, local, fixed, and/or removable storage devices plus storage media for temporarily and/or more permanently containing, storing, transmitting, and retrieving computer-readable information.

Computer-readable storage medium 1520 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 1524 serves as an interface for receiving data from, and transmitting data to, other devices, computer systems, and networks. For example, communication subsystem 1524 may allow computer system 1500 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 1524 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 1524 may provide components configured for wired communication (e.g., Ethernet) in addition to or instead of components configured for wireless communication.

One of ordinary skill in the art will realize that the architecture shown in FIG. 15 is only an example architecture of computer system 1500, and that computer system 1500 may have additional or fewer components than shown, or a different configuration of components. The various components shown in FIG. 15 may be implemented in hardware, software, firmware or any combination thereof, including one or more signal processing and/or application specific integrated circuits.

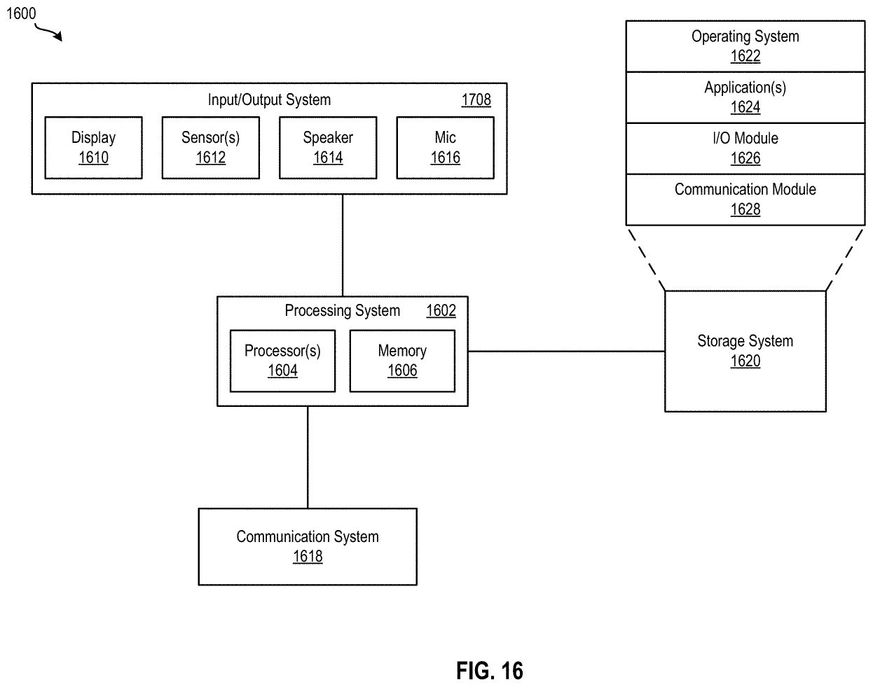

FIG. 16 illustrates an exemplary computing device 1600 for implementing various embodiments described above. For example, computing device 1600 may be used to implement devices client device 100. Computing device 1600 may be a cellphone, a smartphone, a wearable device, an activity tracker or manager, a tablet, a personal digital assistant (PDA), a media player, or any other type of mobile computing device or combination thereof. Some or all elements of client application 105 or combinations thereof can be included or implemented in computing device 1600. As shown in FIG. 16, computing device 1600 includes processing system 1602, input/output (I/O) system 1608, communication system 1618, and storage system 1620. These components may be coupled by one or more communication buses or signal lines.

Processing system 1602, which can be implemented as one or more integrated circuits (e.g., a conventional microprocessor or microcontroller), controls the operation of computing device 1600. As shown, processing system 1602 includes one or more processors 1604 and memory 1606. Processors 1604 are configured to run or execute various software and/or sets of instructions stored in memory 1606 to perform various functions for computing device 1600 and to process data.

Each processor of processors 1604 may include one processing unit (e.g., a single core processor) or several processing units (e.g., a multicore processor). In some embodiments, processors 1604 of processing system 1602 may be implemented as independent processors while, in other embodiments, processors 1604 of processing system 1602 may be implemented as multiple processors integrate into a single chip. Still, in some embodiments, processors 1604 of processing system 1602 may be implemented as a combination of independent processors and multiple processors integrated into a single chip.

Memory 1606 may be configured to receive and store software (e.g., operating system 1622, applications 1624, I/O module 1626, communication module 1628, etc. from storage system 1620) in the form of program instructions that are loadable and executable by processors 1604 as well as data generated during the execution of program instructions. In some embodiments, memory 1606 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1608 is responsible for receiving input through various components and providing output through various components. As shown for this example, I/O system 1608 includes display 1610, one or more sensors 1612, speaker 1614, and microphone 1616. Display 1610 is configured to output visual information (e.g., a graphical user interface (GUI) generated and/or rendered by processors 1604). In some embodiments, display 1610 is a touch screen that is configured to also receive touch-based input. Display 1610 may be implemented using liquid crystal display (LCD) technology, light-emitting diode (LED) technology, organic LED (OLED) technology, organic electro luminescence (OEL) technology, or any other type of display technologies. Sensors 1612 may include any number of different types of sensors for measuring a physical quantity (e.g., temperature, force, pressure, acceleration, orientation, light, radiation, etc.). Speaker 1614 is configured to output audio information and microphone 1616 is configured to receive audio input. One of ordinary skill in the art will appreciate that I/O system 1608 may include any number of additional, fewer, and/or different components. For instance, I/O system 1608 may include a keypad or keyboard for receiving input, a port for transmitting data, receiving data and/or power, and/or communicating with another device or component, an image capture component for capturing photos and/or videos, etc.

Communication system 1618 serves as an interface for receiving data from, and transmitting data to, other devices, computer systems, and networks. For example, communication system 1618 may allow computing device 1600 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1618 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1618 may provide components configured for wired communication (e.g., Ethernet) in addition to or instead of components configured for wireless communication.

Storage system 1620 handles the storage and management of data for computing device 1600. Storage system 1620 may be implemented by one or more non-transitory machine-readable mediums that are configured to store software (e.g., programs, code modules, data constructs, instructions, etc.) and store data used for, or generated during, the execution of the software. Many of the components (e.g., client application 105) described above may be implemented as software that when executed by a processor or processing unit (e.g., processors 1604 of processing system 1602) performs the operations of such components and/or processes.

In this example, storage system 1620 includes operating system 1622, one or more applications 1624, I/O module 1626, and communication module 1628. Operating system 1622 includes various procedures, sets of instructions, software components and/or drivers for controlling and managing general system tasks (e.g., memory management, storage device control, power management, etc.) and facilitates communication between various hardware and software components. Operating system 1622 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 1624 can include any number of different applications installed on computing device 1600. For example, client application 105 may be installed on computing device 1600. Other examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1626 manages information received via input components (e.g., display 1610, sensors 1612, and microphone 1616) and information to be outputted via output components (e.g., display 1610 and speaker 1614). Communication module 1628 facilitates communication with other devices via communication system 1618 and includes various software components for handling data received from communication system 1618.

One of ordinary skill in the art will realize that the architecture shown in FIG. 16 is only an example architecture of computing device 1600, and that computing device 1600 may have additional or fewer components than shown, or a different configuration of components. The various components shown in FIG. 16 may be implemented in hardware, software, firmware or any combination thereof, including one or more signal processing and/or application specific integrated circuits.

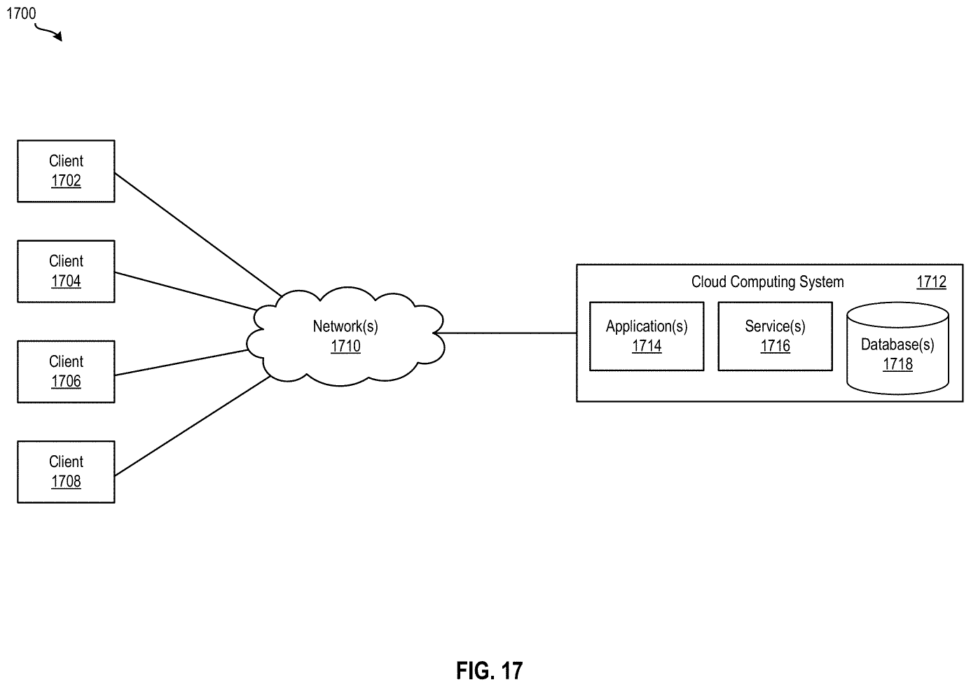

FIG. 17 illustrates an exemplary system 1700 for implementing various embodiments described above. For example, cloud computing system 1712 may be used to implement computing system 110 and client devices 1702-1708 may be used to implement client device 100. As shown, system 1700 includes client devices 1702-1708, one or more networks 1710, and cloud computing system 1712. Cloud computing system 1712 is configured to provide resources and data to client devices 1702-1708 via networks 1710. In some embodiments, cloud computing system 1700 provides resources to any number of different users (e.g., customers, tenants, organizations, etc.). Cloud computing system 1712 may be implemented by one or more computer systems (e.g., servers), virtual machines operating on a computer system, or a combination thereof.

As shown, cloud computing system 1712 includes one or more applications 1714, one or more services 1716, and one or more databases 1718. Cloud computing system 1700 may provide applications 1714, services 1716, and databases 1718 to any number of different customers in a self-service, subscription-based, elastically scalable, reliable, highly available, and secure manner.

In some embodiments, cloud computing system 1700 may be adapted to automatically provision, manage, and track a customer's subscriptions to services offered by cloud computing system 1700. Cloud computing system 1700 may provide cloud services via different deployment models. For example, cloud services may be provided under a public cloud model in which cloud computing system 1700 is owned by an organization selling cloud services and the cloud services are made available to the general public or different industry enterprises. As another example, cloud services may be provided under a private cloud model in which cloud computing system 1700 is operated solely for a single organization and may provide cloud services for one or more entities within the organization. The cloud services may also be provided under a community cloud model in which cloud computing system 1700 and the cloud services provided by cloud computing system 1700 are shared by several organizations in a related community. The cloud services may also be provided under a hybrid cloud model, which is a combination of two or more of the aforementioned different models.

In some instances, any one of applications 1714, services 1716, and databases 1718 made available to client devices 1702-1708 via networks 1710 from cloud computing system 1700 is referred to as a “cloud service.” Typically, servers and systems that make up cloud computing system 1700 are different from the on-premises servers and systems of a customer. For example, cloud computing system 1700 may host an application and a user of one of client devices 1702-1708 may order and use the application via networks 1710.

Applications 1714 may include software applications that are configured to execute on cloud computing system 1712 (e.g., a computer system or a virtual machine operating on a computer system) and be accessed, controlled, managed, etc. via client devices 1702-1708. In some embodiments, applications 1714 may include server applications and/or mid-tier applications (e.g., HTTP (hypertext transport protocol) server applications, FTP (file transfer protocol) server applications, CGI (common gateway interface) server applications, JAVA server applications, etc.). Services 1716 are software components, modules, application, etc. that are configured to execute on cloud computing system 1712 and provide functionalities to client devices 1702-1708 via networks 1710. Services 1716 may be web-based services or on-demand cloud services.

Databases 1718 are configured to store and/or manage data that is accessed by applications 1714, services 1716, and/or client devices 1702-1708. For instance, database 155 may be implemented by databases 1718. Databases 1718 may reside on a non-transitory storage medium local to (and/or resident in) cloud computing system 1712, in a storage-area network (SAN), on a non-transitory storage medium local located remotely from cloud computing system 1712. In some embodiments, databases 1718 may include relational databases that are managed by a relational database management system (RDBMS). Databases 1718 may be a column-oriented databases, row-oriented databases, or a combination thereof. In some embodiments, some or all of databases 1718 are in-memory databases. That is, in some such embodiments, data for databases 1718 are stored and managed in memory (e.g., random access memory (RAM)).

Client devices 1702-1708 are configured to execute and operate a client application (e.g., a web browser, a proprietary client application, etc.) that communicates with applications 1714, services 1716, and/or databases 1718 via networks 1710. This way, client devices 1702-1708 may access the various functionalities provided by applications 1714, services 1716, and databases 1718 while applications 1714, services 1716, and databases 1718 are operating (e.g., hosted) on cloud computing system 1700. Client devices 1702-1708 may be computer system 1500 or computing device 1600, as described above by reference to FIGS. 15 and 16, respectively. Although system 1700 is shown with four client devices, any number of client devices may be supported.

Networks 1710 may be any type of network configured to facilitate data communications among client devices 1702-1708 and cloud computing system 1712 using any of a variety of network protocols. Networks 1710 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A method, comprising:
receiving time series data;
generating a plurality of piecewise linear regression models that fit the time series data, the plurality of piecewise linear regression models having differing numbers of breakpoints;
calculating an information criterion for each of the plurality of piecewise linear regression models;
selecting one of the plurality of piecewise linear regression models having a lowest information criterion, the selected piecewise linear regression model having a set of breakpoints and a set of segments;
for each breakpoint in the set of breakpoints, determining whether to prune the each breakpoint; and
pruning breakpoints in the set of breakpoints that are determined to be pruned.

2. The method of claim 1, further comprising:
for a particular breakpoint that is not pruned, generating a notification for the particular breakpoint; and
for a particular breakpoint that is pruned, discarding the particular breakpoint without generating the notification for the particular breakpoint.

3. The method of claim 1, wherein said determining whether to prune the each breakpoint comprises:
calculating a p-value that a preceding segment to a breakpoint and a succeeding segment to the breakpoint lie on a same line;
determining to prune the breakpoint when the p-value is above a threshold; and
determining not to prune the breakpoint when the p-value is below a threshold;
wherein the threshold is calculated from the sensitivity setting.

4. The method of claim 3, wherein said calculating the p-value comprises:
determining a probability that a slope and intercept of the preceding segment is equal to a slope and intercept of the succeeding segment.

5. The method of claim 3, wherein the threshold is calculated by:
receiving a sensitivity setting;
transforming the sensitivity setting into a corresponding p-value;
correcting for multiple comparisons in the selected piecewise linear regression model by applying a correction to the corresponding p-value, the correction is based on a number of breakpoints in the set of breakpoints.

6. The method of claim 1, further comprising:
determining, based on the time series data, a seasonality interval in the time series data;
wherein the seasonality interval is used as a minimum on segment size during said generating the plurality of piecewise linear regression models.

7. The method of claim 1, wherein the information criterion measures goodness of fit that is penalized by an increasing number of breakpoints.

8. The method of claim 1, further comprising:
detecting one or more outliers in the time series data; and
excluding the one or more outliers during said generating the plurality of piecewise linear regression models.

9. A non-transitory machine-readable medium storing a program executable by at least one processing unit of a device, the program comprising sets of instructions for:
receiving time series data;
generating a plurality of piecewise linear regression models that fit the time series data, the plurality of piecewise linear regression models having differing numbers of breakpoints;
calculating an information criterion for each of the plurality of piecewise linear regression models;
selecting one of the plurality of piecewise linear regression models having a lowest information criterion, the selected piecewise linear regression model having a set of breakpoints and a set of segments;
for each breakpoint in the set of breakpoints, determining whether to prune the each breakpoint; and
pruning the breakpoints in the set of breakpoints that are determined to be pruned.

10. The non-transitory machine-readable medium of claim 9, wherein the program further comprises sets of instructions for:
for a particular breakpoint that is not pruned, generating a notification for the particular breakpoint; and
for a particular breakpoint that is pruned, discarding the particular breakpoint without generating the notification for the particular breakpoint.

11. The non-transitory machine-readable medium of claim 9, wherein said determining whether to prune the each breakpoint comprises:
calculating a p-value that a preceding segment to a breakpoint and a succeeding segment to the breakpoint lie on a same line;
determining to prune the breakpoint when the p-value is above a threshold; and
determining not to prune the breakpoint when the p-value is below a threshold;
wherein the threshold is calculated from the sensitivity setting.

12. The non-transitory machine-readable medium of claim 11, wherein said calculating the p-value comprises:
determining a probability that a slope and intercept of the preceding segment is equal to a slope and intercept of the succeeding segment.

13. The non-transitory machine-readable medium of claim 12,
wherein the threshold is calculated by:
receiving a sensitivity setting;
transforming the sensitivity setting into a corresponding p-value;
correcting for multiple comparisons in the selected piecewise linear regression model by applying a correction to the corresponding p-value, the correction is based on a number of breakpoints in the set of breakpoints.

14. The non-transitory machine-readable medium of claim 9, wherein the program further comprises sets of instructions for:
determining, based on the time series data, a seasonality interval in the time series data;
wherein the seasonality interval is used as a minimum on segment size during said generating the plurality of piecewise linear regression models.

15. The non-transitory machine-readable medium of claim 9, wherein the information criterion measures goodness of fit that is penalized by an increasing number of breakpoints.

16. A system comprising:
a set of processing units; and
a non-transitory machine-readable medium storing instructions that when executed by at least one processing unit in the set of processing units cause the at least one processing unit to:
receive time series data;
generate a plurality of piecewise linear regression models that fit the time series data, the plurality of piecewise linear regression models having differing numbers of breakpoints;
calculate an information criterion for each of the plurality of piecewise linear regression models;
select one of the plurality of piecewise linear regression models having a lowest information criterion, the selected piecewise linear regression model having a set of breakpoints and a set of segments;
for each breakpoint in the set of breakpoints, determine whether to prune the each breakpoint; and
prune breakpoints in the set of breakpoints that are determined to be pruned.

17. The system of claim 16, wherein the instructions further cause the at least one processing unit to:
for a particular breakpoint that is not pruned, generating a notification for the particular breakpoint; and
for a particular breakpoint that is pruned, discarding the particular breakpoint without generating the notification for the particular breakpoint.

18. The system of claim 16, wherein said determining whether to prune the each breakpoint comprises:
calculating a p-value that a preceding segment to a breakpoint and a succeeding segment to the breakpoint lie on a same line;
determining to prune the breakpoint when the p-value is above a threshold; and
determining not to prune the breakpoint when the p-value is below a threshold;
wherein the threshold is calculated from the sensitivity setting.

19. The system of claim 18, wherein said calculating the p-value comprises:
determining a probability that a slope and intercept of the preceding segment is equal to a slope and intercept of the succeeding segment.

20. The system of claim 16, wherein the instructions further cause the at least one processing unit to:
determine, based on the time series data, a seasonality interval in the time series data;
wherein the seasonality interval is used as a minimum on segment size during said generating the plurality of piecewise linear regression models.
